(19) United States
(12) Patent Application Publication
(10) Pub. No.: US 2014/0129967 A1
(43) Pub. Date: May 8, 2014

(54) ONE-HANDED OPERATION

(71) Applicant: University of Maryland, Office of Technology Commercialization, College Park, MD (US)

(72) Inventors: Hanan SAMET, College Park, MD (US); Brendan C. FRUIN, Columbia, MD (US)

(73) Assignee: University of Maryland, Office of Technology Commercializartion, College Park, MD (US)

(21) Appl. No.: 14/071,269

(22) Filed: Nov. 4, 2013

Related U.S. Application Data
(60) Provisional application No. 61/721,939, filed on Nov. 2, 2012.

(51) Int. Cl. G06F 3/048

(52) U.S. Cl. CPC G06F 3/048
USPC 715/765

(57) ABSTRACT

Various devices may benefit from determinations of how users are using the devices. For example, hand-held or hand-operated devices may benefit from handedness detection and from modifications based on or related to such detection. A method can include determining a used hand of a user of a device. The method can also include modifying a graphical user interface of the device based on the determined used hand, wherein determination of the used hand occurs prior to any querying of the user regarding the used hand of the user.

### CROSS REFERENCE TO RELATED APPLICATIONS

This application is related to and claims the priority and benefit of U.S. Provisional Patent Application No. 61/721,939 filed Nov. 2, 2012, which is hereby incorporated herein by reference in its entirety.

### GOVERNMENT LICENSE RIGHTS

This invention was made with government support under IIS0713501 awarded by the NSF. The government has certain rights in the invention.

### BACKGROUND

1. Field

Various devices may benefit from determinations of how users are using the devices. For example, hand-held or hand-operated devices may benefit from handedness detection and from modifications based on or related to such detection. The utility of various devices may benefit from knowledge of how users are using the devices. For example, hand-held or hand-operated devices may benefit from handedness detection and from modification based on or related to such detection.

2. Description of the Related Art

Conventionally, hand-held and similar devices generally are unaware of the way in which they are held by users. In some cases, devices may include accelerometers or the like, which can be used to determine a general orientation of the device. This orientation information can then be used to determine which edge of a display of the device should be the top edge for the purposes of displaying the device so that, for example, the bottom of a displayed image is displayed at the physical bottom of the display. In other words, the orientation information can be used to make sure that displayed images or text do not appear to be rotated by ninety or one-hundred eighty degrees. Such automatic rotation of the screen may ease viewing of the device.

Typically, the main concern is that these devices display an image right side up, as opposed to upside down or rotated by ninety degrees. Thus, it is irrelevant to these devices that they are being held by a user's right hand, a user's left hand, both of a user's hands, or by neither of the user's hands.

In some cases, an application may offer a handedness setting that the user can operate to select a handedness of the user or of the interface. These settings, however, may require a user to go to a settings menu, scroll down to a one-handed preference and select an appropriate preference.

### SUMMARY

According to certain embodiments, a method can include determining a used hand of a user of a device. The method can also include modifying a graphical user interface of the device based on the determined used hand, wherein determination of the used hand occurs prior to any querying of the user regarding the used hand of the user.

In certain embodiments, an apparatus can include at least one processor and at least one memory including computer program code. The at least one memory and the computer program code can be configured to, with the at least one processor, cause the apparatus at least to determine a used hand of a user of a device. The at least one memory and the computer program code can also be configured to, with the at least one processor, cause the apparatus at least to modify a graphical user interface of the device based on the determined used hand, wherein determination of the used hand occurs prior to any querying of the user regarding the used hand of the user.

A method, according to certain embodiments, can include identifying the initiation of a contact to a touch interface. The method can also include setting an area of a display as selected point based on the contact. The method can further include identifying a motion of the contact in a first device. The method can additionally include moving a virtual wheel in response to the motion. The method can also include automatically selecting an item at the selected point when the virtual wheel stops.

An apparatus, in certain embodiments, can include at least one processor and at least one memory including computer program code. The at least one memory and the computer program code can be configured to, with the at least one processor, cause the apparatus at least to identify the initiation of a contact to a touch interface. The at least one memory and the computer program code can also be configured to, with the at least one processor, cause the apparatus at least to set an area of a display as selected point based on the contact. The at least one memory and the computer program code can further be configured to, with the at least one processor, cause the apparatus at least to identify a motion of the contact in a first device. The at least one memory and the computer program code can further be configured to, with the at least one processor, cause the apparatus at least to move a virtual wheel in response to the motion. The at least one memory and the computer program code can additionally be configured to, with the at least one processor, cause the apparatus at least to automatically select an item at the selected point when the virtual wheel stops.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a device according to certain embodiments.

FIG. 3 illustrates a system according to certain embodiments.

FIG. 4 illustrates another method according to certain embodiments.

### DETAILED DESCRIPTION

Various embodiments may relate to methods and systems for making a determination regarding hand position of a user of a hand-held device. The hand-held device may be, for example, a cell phone, a smart phone, a personal digital assistant, a mini-tablet computer, a tablet computer, a portable computer, or the like. Other devices are also permitted. The hand position to be determined may be a hand being used by the user to position and/or operate the device.

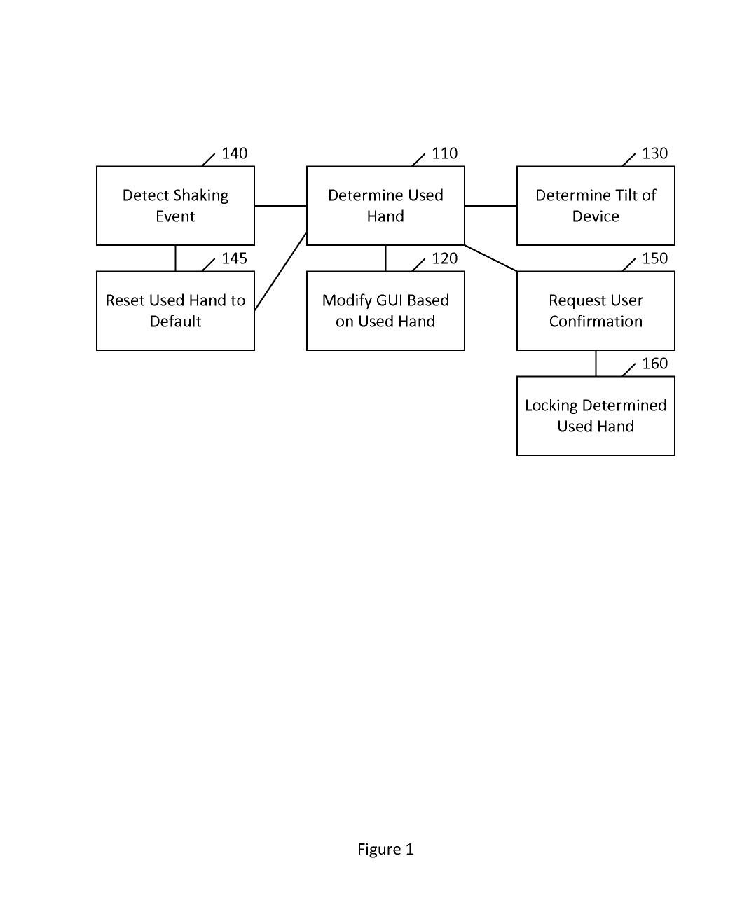

FIG. 1 illustrates a method according to certain embodiments. The method can include, at 110, determining a used hand of a user of a device. The options for the used hand can be left, right, or neutral. The neutral position can include a position in which two hands are being used, no hands are being used, or it cannot be definitely determined which hand is being used.

The method can also include, at 120, modifying a graphical user interface of the device based on the determined used hand, wherein determination of the used hand occurs prior to any querying of the user regarding the used hand of the user.

The modification of the graphical user interface can include modifications such as changing the size, shape, and/or placement of interaction areas on a screen. For example, buttons, taskbars, ribbons, radio buttons, tabs, and the like can be repositioned from a neutral place to a hand-specific place when a specific hand is determined.

For example, when it is determined that a user is using the user's left hand to hold and operate the device, the graphical user interface can be adjusted so that buttons or other interaction areas related to control of the device or of an application on the device, are positioned to the left side. Likewise, when it is determined that a user is using the user's right hand to hold and operate the device, the graphical user interface can be adjusted so that buttons or other interaction areas related to control of the device or of an application on the device, are positioned to the right side. Initially, the buttons or other areas may be larger or duplicated on both sides of a device. The modification may involve reducing the size of the buttons or eliminating the duplicate buttons.

Alternatively, in another example, when it is determined that a user is using the user's left hand to hold and operate the device, the graphical user interface can be adjusted so that buttons or other interaction areas related to control of the device or of an application on the device, are positioned to the right side. Likewise, when it is determined that a user is using the user's right hand to hold and operate the device, the graphical user interface can be adjusted so that buttons or other interaction areas related to control of the device or of an application on the device, are positioned to the left side. This approach may be particularly beneficial when a user's thumb naturally falls on an opposite side of the device, as opposed to naturally falling on a same side of the device.

Thus, when left hand usage is detected, buttons can be positioned to appear in the relaxed left thumb's natural range of motion. Likewise, when right hand usage is detected, buttons can be positioned to appear in the relaxed right thumb's natural range of motion. A thumb's range of motion can be defined to be the arc created by the movement of the thumb from the thumb's starting position parallel to a vertical edge of a device, such as a phone, to when the thumb is perpendicular, or near perpendicular, to the vertical edge such that the thumb remains in a relaxed state without needing to stretch or bend.

In general, with phones having a narrow width, reaching the buttons on the left side of the phone when holding with the left hand may be much harder than reaching the buttons under where the thumb naturally falls. However, there are other phones or other devices that have a larger width, which may make a typical adult left thumb fall closer to the left side. The thumb's range of motion may make a half circle for the area that is easiest to reach and the distance from an edge of this half circle may be harder to reach by either having to bend the thumb or reposition the hand on the phone to stretch the thumb.

The method can further include, at 130, identifying a tilt of the device, wherein an identified tilt of the device is used in determination of the used hand. For example, when the tilt of the device is about seventy degrees from a horizontal level, the determining comprises determining the used hand to be a right hand. The about seventy degree angle can be, for example, from eighty-five degrees to fifty-five degrees or from about seventy-five degrees to about sixty-five degrees.

When the tilt of the device is about one hundred ten degrees from a horizontal level, the determining comprises determining the used hand to be a left hand. The about one hundred ten degree angle can be, for example, from ninety-five degrees to one hundred twenty-five degrees or from about one hundred five degrees to about one hundred fifteen degrees.

When holding a hand held device, the side with the user's thumb and most of the user's palm, may be slightly lower than the opposite side. If this positioning is reversed, the screen tends to point away from the user. When the user uses two hands, both sides may be approximately the same height, namely neutral or perpendicular to the plane.

The method can additionally include, at 140, detecting a shaking event. The shaking event can be used in determination of the used hand. When the shaking event is detected, for example, the determining can be that the used hand is neutral. The method can also include, at 145, when the shaking event is detected, resetting the used hand to be a default value, such as neutral. Neutral can be one example of a default value for used hand. Other default values can be right hand or left hand. A default value can be set based on past usage or can be set by expectation of an application developer. For example, if an application is likely to be used while driving an American-style car, the default hand may be the right hand.

There can be other ways of determining a user's hand position. For example, when it is detected that a device is being used in a landscape mode as distinct from a portrait mode, it can be determined that the hand position is neutral.

In another alternative, the system can initially use buttons on both sides or bars that stretch more than half way across the screen. The system can detect which button is used, for example either a right side button or a left side button. Likewise, the system can detect whether a bar is selected on the left side of the bar or the right side of the bar. The use of one or more left side buttons or the left side of one or more bars may be used as a basis for determining that the user is using a left hand for operation of the device.

As mentioned above, on phones with narrower widths, it may be more natural for a thumb to use certain buttons or portions of bars on an opposite side of the phone. Moreover, in general the thumb of a user may naturally move in an arc across the face of the phone or other device. Thus, the detection of handedness based on button or bar usage may be modified based on, for example, the width of the device.

The identification of which buttons are being used can be combined with tilt information to provide a higher confidence that a particular hand is being used. For example, if a tilt of the device is only about ninety-five degrees but several left hand buttons and no right hand buttons have been used, the system may determine that the device is being used by a left hand. Likewise, even if a tilt of the device is slightly opposite of the result provided by used buttons or bars, the system may give greater weight to the buttons or bars used, in making a determination regarding hand position.

Other factors can also be used. For example, first touch detection on the left side of the screen can suggest that left handed operation is being used, whereas first touch detection on the right side of the screen can suggest that right handed operation is being employed.

A touch interface can also be used in other ways. For example, if a touch interface is configured to detect near touches, near touches can be treated like touches for the purposes of figuring out which side of the screen is favored by the user's hand.

In another example, the shape of touches with the screen may be identified. If oval contact areas are detected with a primary axis leaning to the right (for example, the top end of the oval is to the right and bottom end of the oval is to the left), it may be decided that the user's left hand is being used. Likewise, if oval contact areas are detected with a primary axis leaning to the left, it may be decided that the user's right hand is being used.

Similarly, swipe motion may be analyzed. If an upward swipe trails off to the left, it may be determined that a left hand is being used, whereas if an upward swipe trails off to the right, it may be determined that a right hand is being used. Likewise, if a downward swipe has an arc with an axis off to the left of the device, it may be determined that the left hand is being used, and vice versa for the right hand.

Other sensors can also be used. For example, a camera on the device can take an image of the user and determine whether the image favors a left or right side of the user's face. If the image appears to be taken from the left side of the user, then the system can determine that left-handed operation is being used and vice versa. An infrared sensor or set of sensors can be used to determine if there are infrared sources distributed on one or both sides of the device. If the sources determine a stronger infrared signal from one side or the other of the device, the side with the stronger infrared signal can be identified as the hand of operation.

Accelerometers can also be used to determine whether the device is being twisted about a vertical axis to the left of the device, as may be the case when a left hand is used to operate the device, or being twisted about a vertical axis to the right of the device, as may be the case when a right hand is used to operate the device. The axis of rotation may correspond to the wrist of the user.

The method can further include, at 150, requesting user confirmation of the determined used hand upon determination of the determined used hand. For example, when the determination is made, the user can be prompted to confirm that a particular hand is being used.

The method can additionally include, at 160, locking the determined used hand upon receiving user confirmation as requested. Thus, for example, when the user responds affirmatively to the request for confirmation, the system can stop trying to determine which hand is being used. Alternatively, if the user does not respond negatively to the request for confirmation, the system can stop trying to determine which hand is being used. This locking can be permanent, can be for a predefined duration, or can be for an undefined duration, such as so long as a current application continues to be actively used.

The determining can be performed periodically. The modifying can be performed when the determining has a predetermined confidence. For example, the system can wait for several consecutive determinations of an approximate tilt before deciding that the device is tilted.

Even after the determining has been made with a predetermined confidence and modifying has taken place, the determining can be continued. For example, after the modification has taken place, the frequency of checking the tilt of the device may be dramatically reduced by one or several orders of magnitude.

In another example, after an initial determination of handedness of device usage, the system can search only for large changes in the orientation of the device. For example, if it is detected that the device's orientation has shifted thirty degrees to the left, and the device was previously being used by a right hand, it may be determined that the device is now being used by a left hand, instead. Similarly, if it is detected that the device's orientation has shifted thirty degrees to the right, and the device was previously being used by a left hand, it may be determined that the device is now being used by a right hand, instead.

A trigger for beginning the determining can be the launch of an application or the re-selection of the application after another application had been selected. This trigger may optionally override a previously locked determination.

In certain embodiments, all interactions can be performed with one hand with the hand's thumb serving as the pointing device. In addition to the features described above, operating systems or applications configured to permit one-handed, one-thumbed operation may employ a variety of other features.

For example, the system may employ scrolling systems in which a single item is in a selection area at a given time. The system may present the various items in a way that is visually similarly to the items appearing on the front edge of a wheel whose axis is parallel to the surface of the display, with the selection area being the center of the face of the wheel. In another alternative, the items may be presented between spokes of a wheel whose axis is orthogonal to the surface of the display. A most horizontal section of the wheel may be the selection area at a given a time.

In addition to merely rotating a wheel, the system can also make an automatic selection, as if the user had clicked on the item. Thus, the system can, for example, simulate hovering on a touch device.

Wheel interfaces according to certain embodiments can spin in one direction or two directions. For example, a wheel with a front edge selection area may be configured to spin only down. If the user attempts to spin the wheel the other direction, the system may be configured to take no action in response to such an attempt. Alternatively, the user may be able to spin the wheel in either direction.

In certain embodiments, the wheel may be configured to operate to scroll through a menu of options in response to being spun in a first direction, but may be configured to provide a different action in response to being spun in a different direction. For example, spinning the selection wheel in a first direction may change the selection of menu items. Then, spinning the selection in a second direction may bring up the sub-menu items associated with a currently selected menu item.

Implementation of hovering on a smartphone web browser may be possible in certain embodiments. A web browser can, for example, mimic the effect of the hovering action, which on a conventional desktop and laptop may occur once a user moves the pointing device, by registering the location on the display screen where the hovering action is to take place. This can be done by firing the equivalent of a Javascript mouseover event at the location on the display screen where a tap on a data element occurred, and which registers the location. This can be followed by repeated firings of the mouseover equivalent event as data elements are moved. This may result in an implicit tapping action as the data elements are moved. The data elements may be moved, for example, by a gesturing scrolling action. The repeated firings can be under the location of the last, namely immediately preceding, tap. The repeated firings can be continued until the motion ceases, at which time the final equivalent of a Javascript mouseover event can be fired, which can also fire an event corresponding to a tap, even though no explicit tap took place. The appropriate action is taken for this implicit tap, which can depend on the context in which the original tap and scroll gestures took place. This can be equivalent to moving the pointing device either manually or by scrolling using a mouse wheel or the down and up arrow keys.

The app version can be even simpler, as the built-in table structure of an operating system can be used to store the relative position of the user's last selection when scrolling stopped. Now, when the table detects a subsequent scroll gesture, stories (or other list items) can be updated and the table cell in the stored position can be implicitly tapped when the scroll gesture terminates.

In thumb-only operation, pinch motions may not be possible for zooming Thus, instead a slider or a pair of zoom and unzoom buttons can be provided. The zooming operations can be separately applied to the text in the display and the graphics in the display.

A pair of buttons in the bottom row of the display screen labeled with “+” (plus) and “−” (minus) signs can be used to enable users to zoom in and out, respectively, on the actual text, thereby decoupling the zoom from the links. The use of these buttons can also reformat a webpage so that lines do not wrap around, which can avoid the need to pan.

Buttons such as plus and minus buttons can be arranged for one-handed operation by placing the buttons at angle to one another. Having those buttons at an angle to suit the thumb.

For example, a “+” symbol can be placed above and to the left of the “−” symbol. These symbols can be used for zooming in and zooming out. The plus and minus symbols can be positioned in such a way as to make it easy to zoom in and out with the left thumb while holding the device in the palm of the user's left hand. Furthermore, command icons can be arranged on the bottom of the display in such a way that the infrequently used ones are in a position that is less easy to reach with the left thumb as are the icons that are more frequently used. When a hand change event is detected, the position of these icons can be essentially reversed, so that the plus sign is now up and to the right and the command icons are presented along the bottom in a reversed order. Other similar rearrangements for the convenience of one-handed thumb operation are also possible.

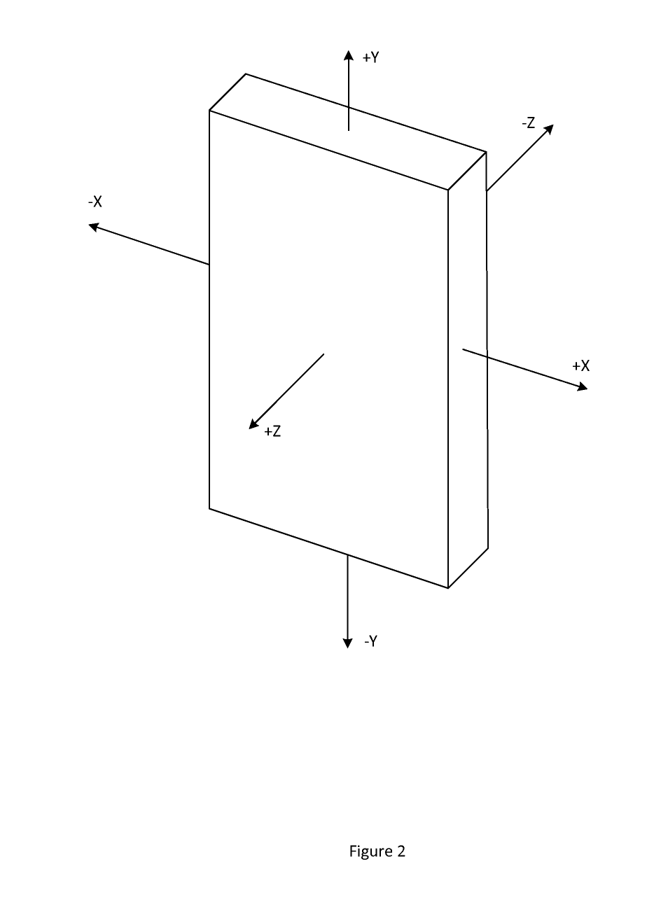

FIG. 2 illustrates a device according to certain embodiments. As shown in FIG. 2, a device may have sensors measuring the orientation of the device with respect to multiple axes. Certain embodiments may employ the idea of level. For example, a level detector or similar feature in the device can used to determine an alignment of the device.

For example, when the device is held in the left hand, then the device may be aligned so that it is leaning towards the left thumb at about 110 degrees relative to a θ (theta) degree horizontal line. On the other hand, if the device is held in the right hand, the device may be aligned so that it is leaning towards the right thumb at about 70 degrees relative to the θ degree horizontal line.

This can all be detected by a program or application (app) similar to that used to provide a level functionality. In this case, the level can be measured relative to the bottom of the device, rather than being measured relative to the earth. For example, the level can be measured in the plane of the display rather than with respect to a strictly vertical plane with respect to the earth's surface. Thus, if the display is leaning forward or backward, this aspect of tilt may be ignored by certain embodiments.

A neutral position can be something that the user sets up by, for example, shaking the device, rather than being a function of the hand in which the device is held. In certain embodiments, a second shake can toggle the device back into automatic detection. Repeated shakings can toggle back and forth between a default setting and automatic detection.

The function of level can be applied by using an application that constantly monitors, for example every 1/60th of a second, the device's orientation in three directions using the device's accelerometer. A vertical orientation x on the accelerometer graph may be the one that is used to detect the identity of the hand holding the device. This approach may be very sensitive to small motions when the device is near a vertical position.

Alternatively, the vertical mode detector in the x direction can be used, but only by looking for very drastic changes in the orientation. This can be done once every second. Constant monitoring of the orientation may lead to quickly exhausting the battery life by, for example, draining it. By contrast, reduced monitoring may avoid draining the battery as quickly.

Small changes in the orientation in the way in which the device is held in one hand may not indicate a change in the hand that holds the device. On the other hand, when changing the hand that holds the device, the change in the orientation is much more pronounced, thereby making it much easier for the system to detect. Thus the user can help the system detect the change in the hand that holds the device by making the orientation change much more pronounced.

It is may feel unnatural to users to hold the device in their left hand while orienting the device so that it is at a 30 degrees angle to the right of the vertical. Thus, the hand that holds the device can be detected in a typical case by assuming the way in which the device is held by a person who wants to make use of it, rather than by a person who wants to trick the sensor into giving a wrong response. This may permit the automatic functioning of the one-handed preference user interface.

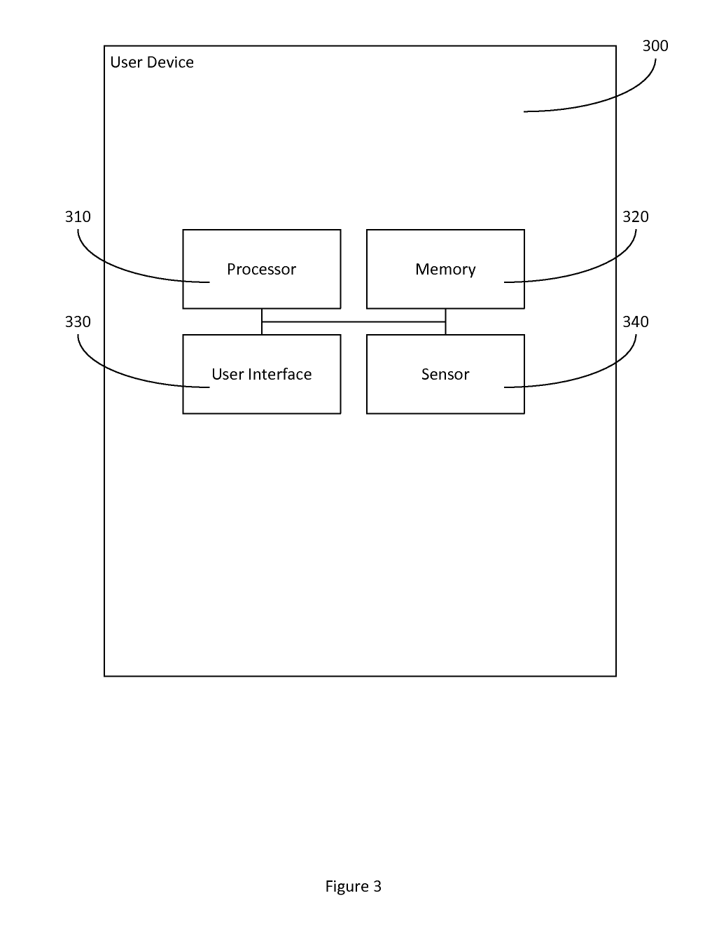

FIG. 3 illustrates a system according to certain embodiments. The system may be or include a user device 310. The system may more particularly include various components of the user device 310. For example, the system may include one or more processor 310 and one or more memory 320.

The processor 310 can be any suitable hardware, such as a controller, a central processing unit (CPU) having one or more cores, or an application specific integrated circuit (ASIC). The processor 310 can have functionality that is distributed over one or more user devices such as user device 300 or served from a remote device.

The memory 320 can include a random access memory (RAM) or read only memory (ROM). The memory 320 can include one or more memory chip, and the memory 320 can be included in a same chip with a processor 310. The memory 320 can be an external memory or a cloud.

The system can also include user interface 330. The user interface 330 can be a display, such as a touch screen display. The user interface 330 can also include other features such as buttons, rollers, joysticks, microphones, or the like. The user interface 330 can provide a graphical user interface to a user of the user device 300.

The system can further include one or more sensor 340. The sensor 340 can be touch-sensitive layer as part of the user interface 330. The sensor 340 can also or additionally be an accelerometer or set of accelerometers in the user device 300. Other sensors, such as cameras, infrared sensors, and the like are also permitted and can be used, for example, as described above.

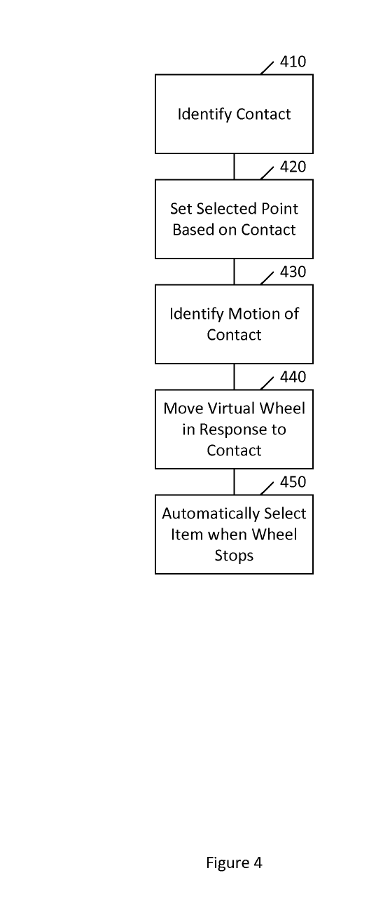

The user device 300 can be configured to perform the method illustrated in FIG. 1, for example. Other implementations are also possible. For example, the user device 300 can be configured to permit a user to use scrolling with automatic selection, in certain embodiments. For example, the user device 300 can implement the method illustrated in FIG. 4. In general, the user device 300 can be configured to perform any of the methods discussed herein, either alone or in combination with other devices or hardware.

FIG. 4 illustrates another method according to certain embodiments. As shown in FIG. 4, the method can include, at 410, identifying the initiation of a contact to a touch interface. In other words, a device can detect that a user has touched a touch screen.

The method can also include, at 420, setting an area of a display as selected point based on the contact. In other words, the point of contact can be set up as the selection area. For example, if a list item is touched, the area where that list item currently is can be configured as a selection area.

The method can further include, at 430, identifying a motion of the contact in a first device. The motion can be a swiping or sliding motion. Other motions are also possible, such as a circular or spiral motion.

The method can additionally include, at 440, moving a virtual wheel in response to the motion. The virtual wheel can be a list arranged to scroll, or a set of items arranged as if on an edge or between spokes of a wheel. There is no requirement that the scrolling list loop around. Moreover, other embodiments are also permitted. For example, the virtual wheel can be a virtual ball with motion permitted in more than one direction and more than one direction simultaneously, like the motion of a globe.

The method can also include, at 450, automatically selecting an item at the selected point when the virtual wheel stops. The motion of the wheel can be controlled precisely by the motion of the user or the wheel can freely spin for a while after the user releases contact. When the wheel stops the selection can occur automatically, for example by treating the area as if it had been clicked by the user.

The method of FIG. 4 may be particularly useful when the touch screen is being operated by a single contact, such as a thumb. The method may permit simulation or substitution of a hover function in a touch screen user interface and may enhance one-handed operation.

The above-described methods can be variously implemented. For example, a non-transitory computer-readable medium can be encoded with instructions that, when executed in hardware, perform a process. The process can correspond to the above-described methods in any of the variations. A computer program product can similarly encode instructions for performing any of the above-described methods in any of the variations. In general, the above-described methods can be implemented in hardware alone or in software running on hardware.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
determining a used hand of a user of a device; and
modifying a graphical user interface of the device based on the determined used hand, wherein determination of the used hand occurs prior to any querying of the user regarding the used hand of the user.

2. The method of claim 1, further comprising:
identifying a tilt of the device, wherein an identified tilt of the device is used in determination of the used hand.

3. The method of claim 2, wherein when the tilt of the device is about seventy degrees from a horizontal level, the determining comprises determining the used hand to be a right hand.

4. The method of claim 2, wherein when the tilt of the device is about one hundred ten degrees from a horizontal level, the determining comprises determining the used hand to be a left hand.

5. The method of claim 1, further comprising:
detecting a shaking event, wherein the shaking event is used in determination of the used hand.

6. The method of claim 5, wherein when the shaking event is detected, the determining comprises determining the used hand to be neutral.

7. The method of claim 5, further comprising:
when the shaking event is detected, resetting the used hand to be neutral.

8. The method of claim 1, further comprising:
requesting user confirmation of the determined used hand upon determination of the determined used hand.

9. The method of claim 8, further comprising:
locking the determined used hand upon receiving user confirmation as requested.

10. The method of claim 1, wherein the determining is performed periodically, and wherein the modifying is performed when the determining has a predetermined confidence.

11. An apparatus, comprising:
at least one processor, and
at least one memory including computer program code,
wherein the at least one memory and the computer program code are configured to, with the at least one processor, cause the apparatus at least to
determine a used hand of a user of a device; and
modify a graphical user interface of the device based on the determined used hand, wherein determination of the used hand occurs prior to any querying of the user regarding the used hand of the user.

12. The apparatus of claim 11, wherein the at least one memory and the computer program code are configured to, with the at least one processor, cause the apparatus at least to identify a tilt of the device, wherein an identified tilt of the device is used in determination of the used hand.

13. The apparatus of claim 12, wherein when the tilt of the device is about seventy degrees from a horizontal level, the at least one memory and the computer program code are configured to, with the at least one processor, cause the apparatus at least to determine the used hand to be a right hand.

14. The apparatus of claim 12, wherein when the tilt of the device is about one hundred ten degrees from a horizontal level, the at least one memory and the computer program code are configured to, with the at least one processor, cause the apparatus at least to determine the used hand to be a left hand.

15. The apparatus of claim 11, wherein the at least one memory and the computer program code are configured to, with the at least one processor, cause the apparatus at least to detect a shaking event, wherein the shaking event is used in determination of the used hand.

16. The apparatus of claim 15, wherein when the shaking event is detected, the at least one memory and the computer program code are configured to, with the at least one processor, cause the apparatus at least to reset the used hand to be neutral.

17. The apparatus of claim 11, wherein the at least one memory and the computer program code are configured to, with the at least one processor, cause the apparatus at least to request user confirmation of the determined used hand upon determination of the determined used hand.

18. The apparatus of claim 17, wherein the at least one memory and the computer program code are configured to, with the at least one processor, cause the apparatus at least to lock the determined used hand upon receiving user confirmation as requested.

19. The apparatus of claim 11, wherein the at least one memory and the computer program code are configured to, with the at least one processor, cause the apparatus at least to perform the determination periodically, and to perform modification of the graphical user interface when the determination has a predetermined minimum confidence.

20. A method, comprising:
identifying the initiation of a contact to a touch interface;
setting an area of a display as selected point based on the contact;
identifying a motion of the contact in a first device;
moving a virtual wheel in response to the motion; and
automatically selecting an item at the selected point when the virtual wheel stops.
